(19) United States
(12) Patent Application Publication
(10) Pub. No.: US 2015/0289488 A1
(43) Pub. Date: Oct. 15, 2015

(54) SYSTEM FOR CREATING A VERTICAL WATER FLOW IN A WATER COLUMN

(71) Applicants: Andrew James Rella, Staten Island, NY (US); Lun Yin, Jersey City, NJ (US)

(72) Inventors: Andrew James Rella, Staten Island, NY (US); Lun Yin, Jersey City, NJ (US)

(21) Appl. No.: 14/687,646

(22) Filed: Apr. 15, 2015

Related U.S. Application Data
(63) Continuation of application No. 61/979,872, filed on Apr. 15, 2014.

(51) Int. Cl. A01K 61/00; F17D 1/14

(52) U.S. Cl. CPC A01K 61/006; A01K 61/00; A01K 61/002; A01K 61/005; F17D 1/14

(57) ABSTRACT

A system for creating a vertical water flow in a water column that includes a first portion, and a second deeper portion is provided including a down-welling mechanism positioned within the water column. The down-welling mechanism is configured to create the vertical water flow downward to the second, deeper portion of the water column.

### CROSS-REFERENCE TO RELATED APPLICATION

This application claims the benefit of U.S. provisional patent application Ser. No. 61/979,872 filed Apr. 15, 2014, the entire contents of which are incorporated herein by reference.

### BACKGROUND

Exemplary embodiments of the present disclosure relates to the fields of hydraulic engineering, marine biology, and coastal engineering.

By employing natural habitat elements for shore stabilization purposes, it is possible to create habitats, improve water quality, improve the aesthetics of our natural shores, as well as stabilize erosion. “Living shorelines” come in many forms and are defined as any structure that promotes habitat development. Examples of living shorelines range from traditional structures that have vegetation incorporated into their design (hybrid structures), to structures comprised solely of natural components. The ecosystem services provided by enhanced infrastructure habitats include, but are not limited to, improved water quality, increased operational life span, structural stability, and the absorption of hydrodynamic forces. The success of habitat development of any kind is very dependent upon water quality, temperature, available light and position within the water column.

In the northeast, living breakwaters are typically constructed using oysters or mussels as the dominant species; however, oyster and mussel reef systems require specific conditions in order for the species to thrive and become self-sustaining. Oysters are normally cultured near the surface of a body of water where the highest flow rates and the highest transfer rate of phytoplankton and algae upon which oysters feed are located. At greater depths, however, waters are less oxygenated and may be relatively nutrient poor compared to the surface waters.

Increasing the oyster population in a body of water could have dramatic positive effects such as creating nesting grounds and improving water quality. In addition, since it has been proven that oysters are capable of increasing the structural strength of the concrete on which they grow, developing methods that encourage growth at greater depths may increase the surface area of the concrete to be covered, thereby strengthening a greater percentage of the structure. Even in bodies of water with low flow rates, a permanent and constant flow of highly oxygenated and nutrient rich surface water could have benefits for developing abundant and diverse aquatic communities.

### SUMMARY

According to an embodiment of the present disclosure, a system for creating a vertical water flow in a water column that includes a first portion, and a second deeper portion is provided including a down-welling mechanism positioned within the water column. The down-welling mechanism is configured to create the vertical water flow downward to the second, deeper portion of the water column.

According to another embodiment of the present disclosure, a method for moving water from a first portion of a water column to a second, deeper portion of the water column is provided including oscillating a down-welling mechanism positioned within the water column to create a vertical water flow downward to the second, deeper portion of the water column.

### BRIEF DESCRIPTION OF THE DRAWINGS

The subject matter, which is regarded as the present disclosure, is particularly pointed out and distinctly claimed at the conclusion of the specification. The foregoing and other features and advantages of the present disclosure are apparent from the following detailed description, taken in conjunction with the accompanying drawings, in which:

FIG. 1 is a schematic diagram of a system for creating a vertical water flow in a water column according to an embodiment of the present disclosure;

FIG. 2 is a perspective view of a system for creating a vertical water flow in a water column according to another embodiment of the present disclosure;

FIG. 3 is a perspective view of a body of water having a plurality of systems for creating a vertical water flow installed therein according to an embodiment of the present disclosure; and

FIG. 4 cross-sectional view of a down-welling mechanism according to an embodiment of the present disclosure.

The detailed description of the invention describes exemplary embodiments of the invention, together with some of the advantages and features thereof, by way of example with reference to the drawings.

### DETAILED DESCRIPTION OF THE INVENTION

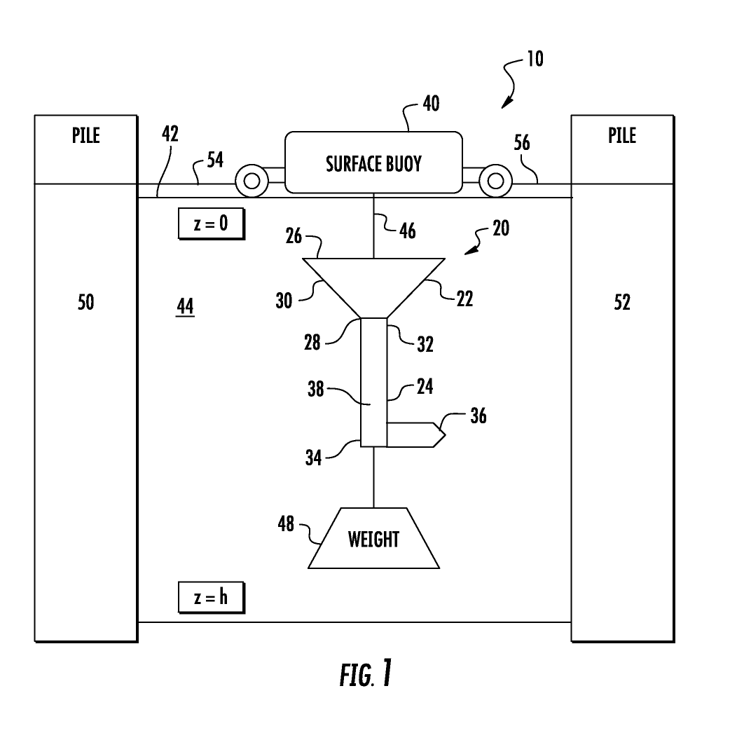

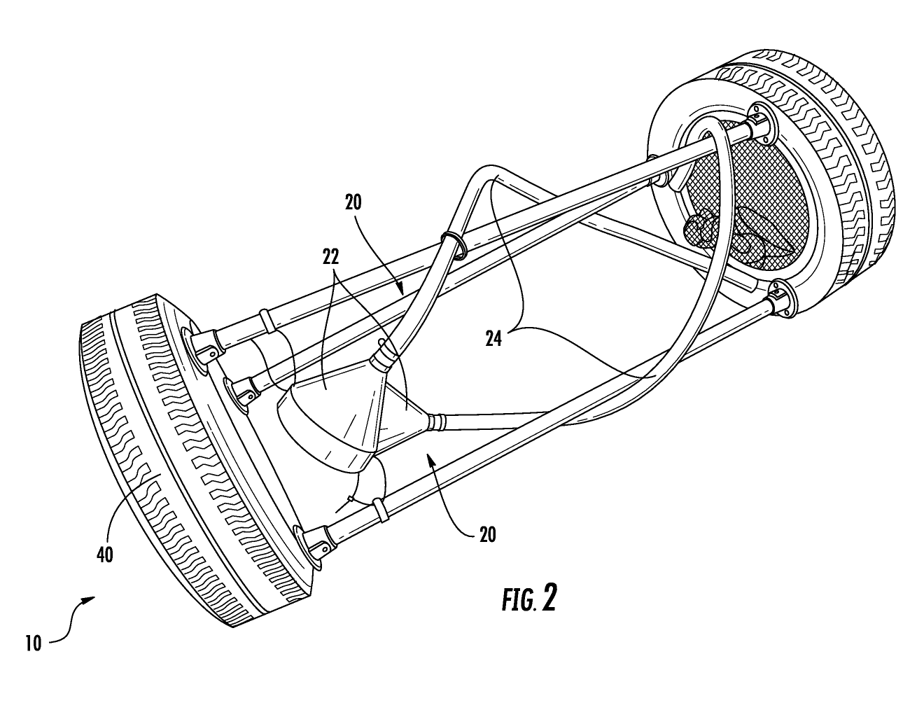

Referring now to the FIG. 1, a system for creating a vertical water flow in a water column 10 according to an embodiment of the present disclosure is illustrated. The system 10 includes a down-welling mechanism 20 having a funnel 22 and a generally hollow discharge line 24, such as a pipe, hose, or other conduit for example. The funnel 22 has a first open end 26 having a first diameter and a second open end 28 having a second diameter. As shown, the diameter of the second open end 28 is generally smaller than the diameter of the first open end 26. The diameter of the portion 30 of the funnel 22 extending between the first end 26 and the second end 28 may be configured to decrease uniformly (as shown in FIGS. 1 and 2), or alternatively, may decrease non-uniformly such that a plurality of distinct angles are formed in the portion 30 of the funnel 22 extending between the first end 26 and the second end 28.

A first end 32 of the discharge line 24 is arranged in fluid communication with the second open end 28 of the funnel 22. The discharge line 24 may be coupled to the funnel 22, such as with a connector or fitting (not shown) for example, or alternatively, may be integrally formed with the second, free end 34 of the funnel. At least one discharge outlet 36 is arranged near the second end 34 of the discharge line 24. In one embodiment the discharge outlet 36 is formed at the second, open end 34 of the discharge line 24. In another embodiment, the at least one discharge outlet 36 includes one or more openings (not shown) formed in a sidewall 38 of the discharge line 24, for example adjacent the second end 34, such that fluid within the discharge line 24 is expelled radially through the at least one opening.

The down-welling mechanism 20 is configured to prevent a backflow of water towards the funnel 22. In the illustrated, non-limiting embodiment, backflow is prevented by configuring the discharge line 24 such that a flow path of the fluid expelled from the discharge line 24 is arranged at an angle relative to a vertical axis defined by the discharge line 24. Alternatively, or in addition, a check valve (not shown) may be provided at one or more locations within the discharge line 24 to physically block an upward flow there through.

With continued reference to FIG. 1, the system 10 may further include a floating device 40, such as a buoy for example. The floating device 40 may be arranged at the surface 42 of a body of water 44, or alternatively, may be submerged under the surface 42. The floating device 40 is configured to attach to a portion of the down-welling mechanism 20 to retain and support a submerged down-welling mechanism 20 when installed within a body of water 44. As shown, the first end 26 of the funnel 22 may be connected by one or more connecting members 46, such as ropes or chains for example, to an adjacent surface of the floating device 40. The floating device 40 may have any of a plurality of configurations and should be selected based on a desired application. In addition, embodiments where more than one down-welling mechanism 20 is connected to a single floating device 40, such as shown in FIG. 2 for example, are also within the scope of the invention.

A weight 48 may also be coupled to a portion of the down-welling mechanism 20 to maintain a generally vertical orientation of the funnel 22. In addition, the weight 48 may be configured to anchor the down-welling mechanism 20, thereby limiting the down-welling mechanism 20 from moving a significant horizontal distance from its intended position. In another embodiment, horizontal movement of the mechanism 20 is limited by tethering a portion of at least one of the down-welling mechanism 20 and the floating device 40 to a stationary structure. In the illustrated, non-limiting embodiment of FIG. 1, the floating device 40 connected to the down-welling mechanism 20 is affixed to piles 50, 52 by tethers 54, 56.

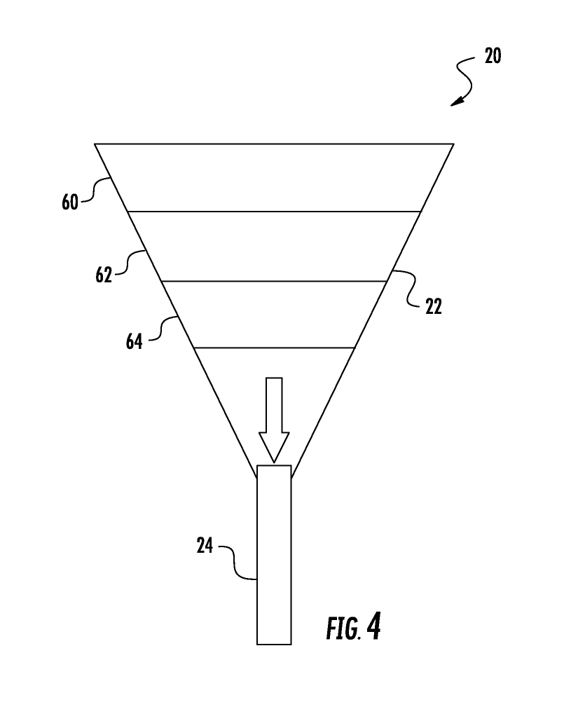

The system 10, and in particular the down-welling mechanism 20 thereof is driven by wave forces and oscillation. The down-welling mechanism 20 is a pumping device configured to transfer oxygenated and nutrient rich water from near the surface 42 of a body of water 44 to a deeper portion of the body of water 44, such as within a water column. During oscillation of the system 10, the shape of the funnel 22, more specifically the decreasing diameter thereof, produces a downward flow as a larger volume of water adjacent the first open end 26 enters a smaller volume of space near the second end 28. This may be further understood by conceptually separating the funnel 22 into a plurality of segments 60, 62, 64 having substantially equal vertical dimensions, as illustrated in FIG. 4. If the vertical dimension of each segment 60, 62, 64 is the expected heave of the floating device 40 as it oscillates up and down, the volume of water originally contained within segment 60, will be transferred to segment 62, and the volume of water originally contained within segment 62 is transferred to segment 64. By forcing the larger volume of water originally within segment 60 into a smaller volume of space defined by segment 62, the flow rate of water from segment to segment is accelerated. As a result of the continued decrease in diameter of portion 30 of the funnel 22, this phenomenon of increased flow rate is experienced over the height of the funnel 22 until the water disposed therein is ultimately forced into the discharge line 24.

An advantage of the system 10 as described herein is that it operates solely in response to wave-driven oscillation or heaving and does not require another power source. The system 10 may be used in any body of water 44 where a form of waves is present to continuously drive a flow of water from near the surface 42 (indicated in FIG. 1 by the height z=0) towards a deeper portion of a water column (indicated in FIG. 1 by the height z=h). For example, in areas having busy ferry schedules, such as the Hudson River or East River for example, a constant source of waves produced from the boat wakes may be sufficient to power a down-welling pump when wind is not present. This operability of the system 10, independent from an electrical or mechanical power supply allows deployment of the system 10 in remote areas. In addition, the design of the system 10 and the down-welling mechanism 20 thereof eliminates the need for moving and mechanical parts, thereby reducing the potential for maintenance and the costs associated therewith.

During validation of the basic concept of the system 10, it was determined that the down-welling mechanism 20 functions most efficiently when the attached floating device 40 follows the motion of the surface 42 of the water 44 with minimal deviation. By visually observing the motion of the buoy 40 supporting the mechanism 20 and the flow rate of the water being pumped, while exposing the system to waves of varying height and lengths, several conclusions were drawn. For example, when the buoy 40 interacted with a wave having a length shorter than a diameter of the buoy 40, the buoy 40 would deviate from the motion of the water, moving inconsistently in all six degrees of freedom and resulting in an extremely low flow rate. When placed in an environment consisting of waves having a wave length longer than the diameter of the buoy 40, the buoy 40 followed the motion of the surface 42 more accurately. Although sonic movement still occurred in the six degrees of freedom, this was generally limited and an increase in heave produced higher flow rates. The test down-welling mechanism 20 was most effective when a diameter of the buoy 40 was approximately equal to the length of the wave. This resulted in the buoy 40 moving horizontally up and down with the greatest amount of heave.

Similarly, it was determined that an increase in wave height would result in greater amounts of heave, and therefore would increase the flow rate of the down-welling mechanism 20. However, steepness of the wave is also an important consideration as it dictates a tilting angle of the mechanism 20 as the buoy 40 follows the motion of the wave. As the angle of the buoy 40 increases from a horizontal plane, the flow rate of the down-welling mechanism 20 decreases.

Additional testing also showed that the down-welling mechanism 20 of the system 10 may be used as an eductor to draw water through a discharge line 24 configured as a suction line.

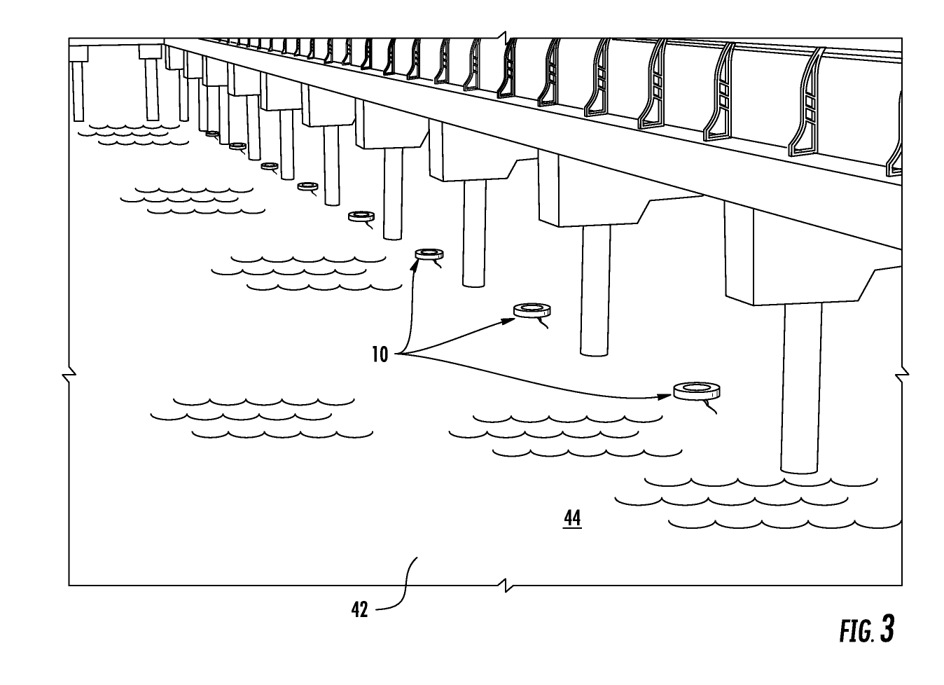

By positioning a plurality of systems 10 in the same location, or strategically placing them in the vicinity of a potential habitat, as shown in FIG. 3, it is possible to alter the water quality conditions of the water column in which they are located. Over time, the continual delivery of water enriched with oxygen, nutrients, and potential food, such as phytoplankton and algae for example, into deeper regions of the water column will encourage habitat development, thereby decreasing the zone of biological inactivity due to insufficient sunlight or oxygenation. Applications in which one or more systems 10 may be used include: deploying the systems 10 between piles 50, 52 to encourage living reefs, deploying the systems 10 off the ends of floating docks to improve circulation in marinas, mooring the systems 10 on a shoreward side of offshore breakwaters to improved water quality in confined spaces, placement of systems 10 in front of bulkheads to encourage habitats along toe stone revetments, and placement of systems 10 in high density areas to combat hypoxia or dead zones. One or more down-welling systems 10 may also be placed in fisheries or oyster hatcheries as an emergency method for circulating water in the case of a power outage. It should be understood that the applications described herein are intended as examples only, and other applications of the system 10 are within the scope of the present disclosure.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for creating a vertical water flow in a water column that includes a first portion and a second, deeper portion, the system comprising:
a down-welling mechanism positioned in the water column, wherein said down-welling mechanism is configured to create the vertical water flow downward to the second, deeper portion of the water column.

2. The system of claim 1, wherein said down-welling mechanism being driven in response to oscillation of the water column.

3. The system of claim 2, wherein the first portion of the water column includes a surface and wherein said down-welling mechanism being driven in response to oscillation of the water surface.

4. The system of claim 1, wherein the down-welling mechanism is a pumping device including:
a funnel including a first open end having a first diameter and a second open end having a second diameter; and
a discharge line arranged in fluid communication with said second open end, said discharge line including a discharge outlet.

5. The system according to claim 4, wherein said discharge line is coupled to said funnel with a connector.

6. The system according to claim 4, wherein said discharge line is integrally formed with said funnel.

7. The system according to claim 4, wherein said discharge outlet includes at least one opening formed adjacent an end of said discharge line.

8. The system according to claim 4, wherein the pumping device is configured to limit backflow toward said funnel.

9. The system according to claim 8, wherein said discharge outlet is configured such that water is expelled from said discharge line at an angle relative to a vertical axis defined by said discharge line.

10. The system according to claim 4, wherein a decrease in diameter of said funnel extending between said first open end and said second open end accelerates water through said funnel into said discharge line.

11. The system according to claim 1, further comprising:
a floating device coupled to a portion of said down-welling mechanism, said floating device being configured to support said down-welling mechanism within a body of water.

12. The system according to claim 1, further comprising:
a weight coupled to a portion of said down-welling mechanism, said weight being configured to maintain a generally vertical orientation of said down-welling mechanism.

13. The system according to claim 1, further comprising:
a stationary structure to which said down-welling mechanism is attached.

14. The system according to claim 1, wherein said down-welling mechanism is submerged within the water column.

15. A method for moving water from a first portion of a water column to a second, deeper portion of the water column, comprising:
oscillating a down-welling mechanism positioned in the water column to create a vertical water flow downward to the second, deeper portion of the water column.

16. The method according to claim 15, wherein said oscillating of said down-welling mechanism is configured to accelerate a flow rate of water within said down-welling mechanism.

17. The method according to claim 15, wherein the down-welling mechanism is a pumping device including:
a funnel including a first open end having a first diameter and a second open end having a second diameter; and
a discharge line arranged in fluid communication with said second open end, said discharge line including a discharge outlet.

18. The method according to claim 15, wherein the down-welling mechanism is submerged within the water column.

19. The method according to claim 15, wherein the down-welling mechanism is configured to limit backflow toward said funnel.

20. The method according to claim 15, wherein said discharge outlet is configured such that water is expelled from said discharge line at an angle relative to a vertical axis defined by said discharge line.
